(19) United States
(12) Patent Application Publication
(10) Pub. No.: US 2013/0008837 A1
(43) Pub. Date: Jan. 10, 2013

(54) Sorting apparatus

(75) Inventor: Johan Calcoen, Leuven (BE)

(73) Assignee: Key Technology, Inc.

(21) Appl. No.: 13/135,499

(22) Filed: Jul. 6, 2011

(51) Int. Cl. B07C 5/342; B07B 4/02

(52) U.S. Cl. 209/644; 209/606

(57) ABSTRACT

A sorting apparatus is described and which includes a substantially continuous source of a product to be sorted; and a downwardly oriented supporting surface for guiding the source of product for movement, at least in part, under the influence of gravity, along a path of travel through a first inspection station which is oriented along the supporting surface, and where the product is first inspected, and then travels to a second location or station, which is located off the supporting surface, and where, at the second location or station, individual defective products are removed from the substantially continuous source of product to be sorted.

### TECHNICAL FIELD

The present invention relates to a sorting apparatus, and more specifically to a sorting apparatus which provides a convenient means for orienting a stream of both acceptable and unacceptable products; imaging the stream of products; identifying unacceptable products; and then removing the unacceptable products at a downstream location.

### BACKGROUND OF THE INVENTION

The prior art is replete with numerous differently designed sorting apparatus which have been utilized to orient a stream of products in a given path of travel, and which further provides a means for both illuminating; visually identifying defective products; and then later, in a downstream process, removing the defective products from the stream of products which are provided. An example of such an apparatus includes U.S. Pat. No. 6,305,551, the teachings of which are incorporated by reference, herein. In the aforementioned U.S. patent, the inventors have described a proposed device which enables substantially all low-quality and unacceptable products, and foreign bodies, to be removed from a product stream in an efficient, fast, and extremely accurate way so that a high-quality end product is obtained, with the loss of good product being reduced. This invention claims to reach these objectives by providing an arrangement whereby no extra product position determination, or product speed determination has to be carried out during the operation of the device. Furthermore, the invention claims that it's advantages include a construction which is extremely simple and which permits it to process a higher flow rate of products to be sorted than what has been available, heretofore.

Other prior art devices have attempted to provide a means for sorting products of various types having designs similar to that seen in U.S. Pat. No. 6,305,551. For example, the Office's attention is directed to the teachings of U.S. Pat. No. 3,097,744 to Hutter et al., and which is incorporated by reference, herein. The Office will note that this reference shows the use of a ramp like assembly, and a means by which defective products may be identified, and thereafter removed in a downstream process. The Office's attention is also directed to U.S. Pat. No. 3,216,567 which has a similar arrangement, and which provides a means for removing identified, defective products. The Office's attention is also invited to U.S. Pat. No. 4,365,719 which shows an assembly very similar to that described in the aforementioned U.S. Pat. No. 6,305,551.

While the U.S. Patents, noted above, have worked with some degree of success, they have had numerous shortcomings which have detracted from their usefulness. Chiefly, among the shortcomings which have been experienced, has been the propensity for such devices to not readily adapt to differing streams of products without substantial adjustments being made in the illumination, and imaging of the stream of product as it proceeds to a downstream sorting station.

The present invention provides a new and novel means for imaging, and sorting a stream of products in a manner not possible heretofore, and avoids the shortcomings attendant with the prior art practices.

### SUMMARY OF THE INVENTION

A first aspect of the present invention relates to a sorting apparatus which includes a substantially continuous source of a product to be sorted; and a downwardly oriented supporting surface for guiding the source of product for movement, at least in part, under the influence of gravity, along a path of travel through a first location which is located along the supporting surface, and where the product is first inspected, and then travels to a second location, which is located off the supporting surface, and where, at the second location, individual defective products are removed from the substantially continuous source of product to be sorted.

Still another aspect of the present invention relates to a sorting apparatus, which includes a substantially continuous source of a discrete product to be sorted, and which includes a multiplicity of both acceptable products, and unacceptable products; a supporting surface for guiding the continuous source of the discrete product along a downwardly directed path of travel through a first inspection station, and a second sorting station, and wherein the supporting surface simultaneously facilitates the acceleration of the substantially continuous source of product to about a free-fall speed, and further orients the multiplicity of both acceptable and unacceptable products into a single layer, and wherein the supporting surface is discontinuous, and defines a gap in the first inspection station; a stream of compressed air is provided and is introduced into the gap, and which is effective in supporting the substantially continuous source of discreet product for movement across the gap, while not substantially changing the respective downwardly directed paths of travel of the multiplicity of both acceptable and unacceptable products; a visual inspection assembly which is located in spaced relation relative to the first inspection station, and which illuminates and images along a line of reference which is positioned within the gap, and substantially transversely relative to the respective downwardly directed paths of travel of the multiplicity of both acceptable and unacceptable products, and wherein the visual inspection assembly provides a signal which identifies unacceptable products which move through the gap; and a product rejection assembly positioned in the second sorting station, and which is coupled in signal receiving relation relative to the visual inspection assembly, and wherein, in response to a signal received from the visual inspection station, the product rejection station removes previously identified unacceptable products from the downwardly directed paths of travel so as to produce a continuous source of product having only individual, acceptable products.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a greatly simplified, schematic, side-elevation view of one form of the sorting apparatus of the present invention.

FIG. 2 is a greatly simplified, schematic depiction showing several features of the present invention.

FIG. 3A is a greatly simplified, fragmentary, side-elevation view of one form of the present invention

FIG. 3B is a greatly simplified, fragmentary, side-elevation view of a second form of the present invention.

FIG. 3C is a greatly simplified, fragmentary, side-elevation view of a third form of the present invention.

FIG. 3D is a greatly simplified, fragmentary, side-elevation view of a fourth form of the present invention.

FIG. 4 is a greatly simplified, enlarged, side-elevation view of one form of the present invention.

FIG. 5 is an enlarged, fragmentary, side-elevation view of another form of the present invention.

FIG. 6 is yet another enlarged, fragmentary view of the present invention.

FIG. 7 is still another enlarged, fragmentary view of another form of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

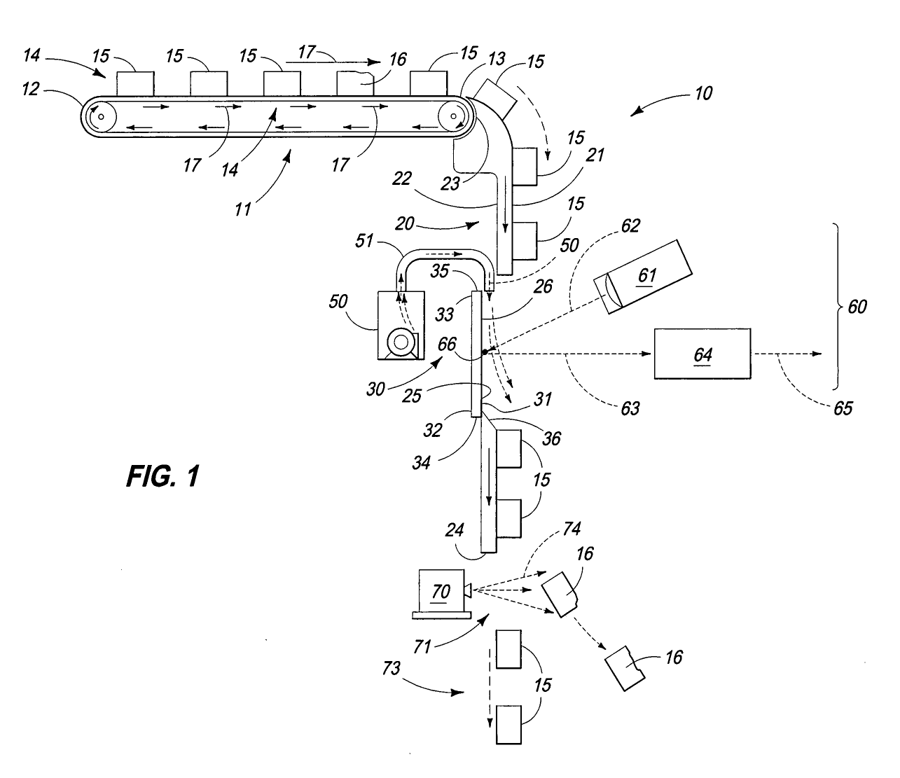

A sorting apparatus of the present invention is generally indicated by the numeral 10 in FIG. 1 and following. Referring now to the drawings, it will be seen that the present sorting apparatus 10 is used in combination with a conveyor assembly 11 of conventional design. The conveyor assembly as illustrated is a continuous belt conveyor, however, other assemblies including vibratory conveyors of various types may be utilized with equal success. The conveyor assembly 11 includes a first or intake end 12, and a second or discharge end 13. The conveyor assembly is operable to transport a substantially continuous source of a product to be sorted 14, and which includes both individual acceptable products 15, and unacceptable products which are generally indicated by the numeral 16. The conveyor assembly 11 moves the source of a product to be sorted 14 along a path of travel which is generally indicated by the numeral 17.

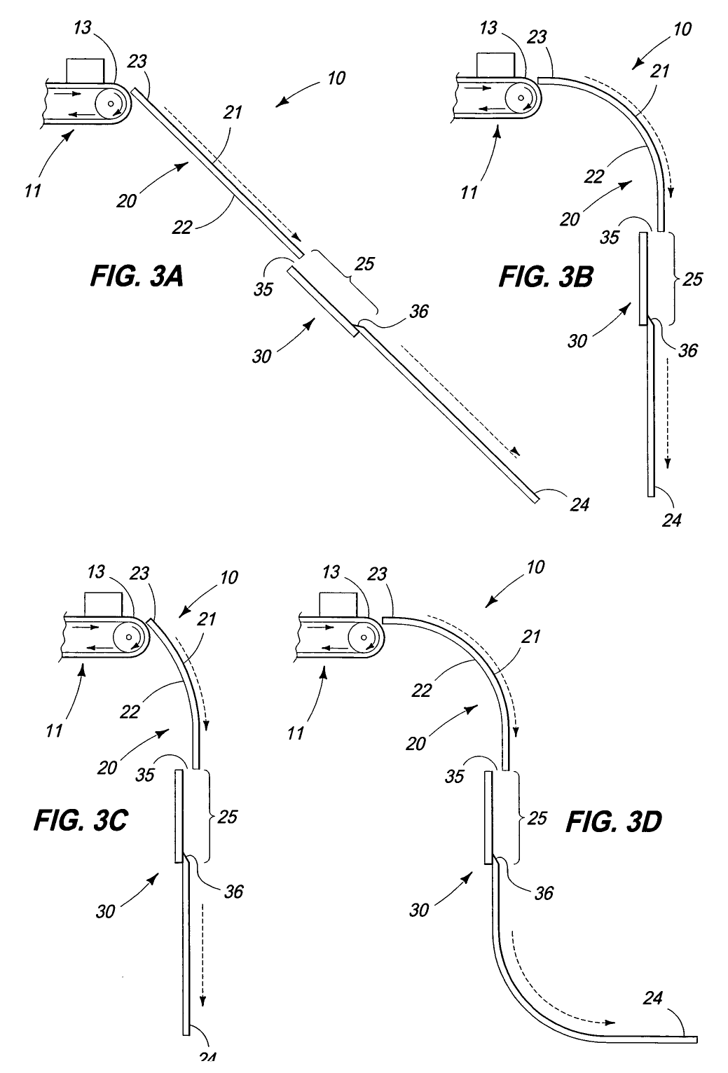

As seen in FIG. 1, and following, the sorting apparatus 10 includes a downwardly oriented supporting surface, which is generally indicated by the numeral 20, and which is useful for guiding the source of product to be sorted 14, for movement under the influence of gravity along a path of travel where the product 14 is first inspected, and then travels to an off-surface and downstream sorting location where individual unacceptable or defective products 16 are removed from the substantially continuous source of the product to be sorted 14. More specifically, and in all the forms of the invention, as shown, the downwardly oriented supporting surface facilitates the substantially continuous source of products 14 to be sorted to accelerate, at least temporarily, to a speed which approximates free-fall. In the several forms of the invention 10 as seen, hereinafter, the substantially continuous source of product 14 is accelerated to a speed where individual products within the continuous source of product 14 to be sorted move along substantially parallel downwardly directed paths of travel, and further have no substantial movement in a direction which is transverse, or horizontal to the respective parallel paths of downwardly directed travel. Still further, the downwardly oriented supporting surface facilitates the orientation of the substantially continuous source of product 14 to be sorted into a single layer. As seen by a study of the drawings, the downwardly oriented supporting surface 20 has a shape, as measured in the direction of travel of the substantially continuous source of product to be inspected 14 that is either, concavely curved; or convexly curved; or substantially planar or combinations of the foregoing. Such is seen by a study of FIGS. 3A-3D, respectively. The downwardly oriented supporting surface 20 is fabricated of a material which does not substantially frictionally impede the movement of the continuous source of product 14 to be sorted while moving under the influence of gravity along the downwardly oriented supporting surface 20.

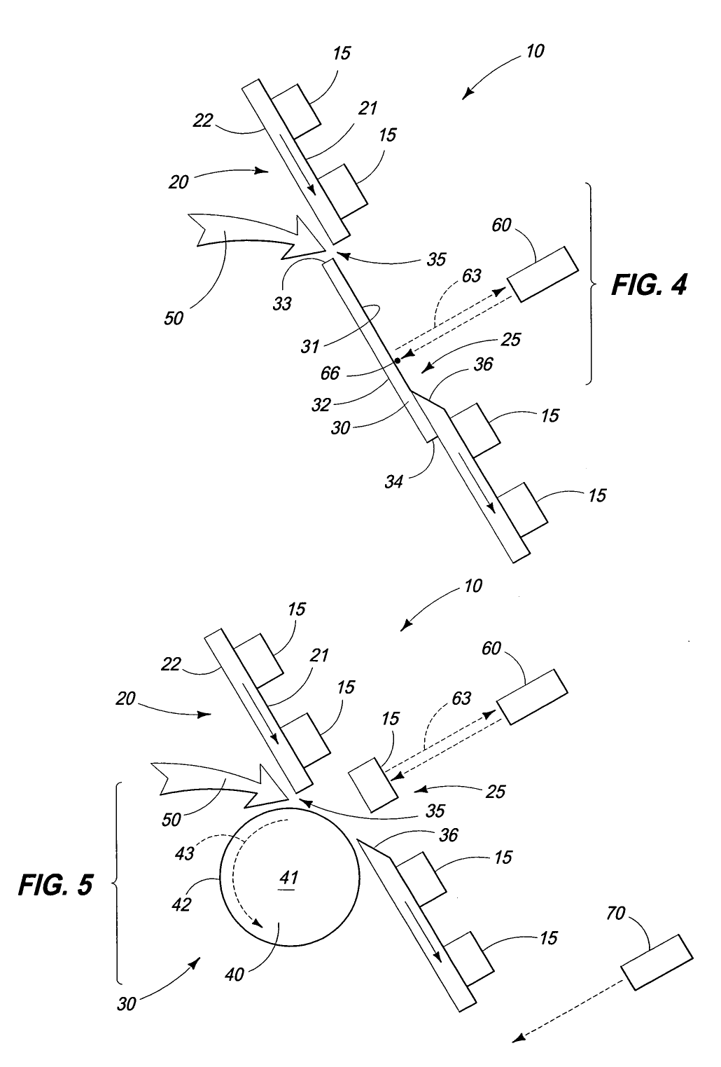

The downwardly oriented supporting surface 20 is defined by a top or outwardly facing surface 21, and an opposite, bottom facing surface 22. The downwardly oriented supporting surface has a first or proximal end 23, and a second or distal end 24. In one possible form of the invention, which is not shown, the proximal end may include a structure which forms discrete lanes through which the product may travel. These lanes would have the effect of causing the product to align and to otherwise singulate as the product 14 moves under the influence of gravity along the supporting surface 20. The source of product to be sorted 14 travels from the proximal end 23 to the second or distal end 24 under the influence of gravity. As seen in the various drawings that are provided, the downwardly oriented supporting surface is discontinuous, and defines a gap 25 of predetermined dimensions in a first location or station 26. As will be appreciated by a study of the various drawings, the substantially continuous source of product to be inspected 14 travels across the gap 25 by the force of gravity. As seen by reference to FIG. 1 and following, the sorting apparatus 10 includes a visual reference which is generally indicated by the numeral 30, and which is affixed to but located in predetermined, spaced relation relative to the bottom surface 22 of the downwardly oriented supporting surface 20. The visual reference is located in substantially covering relation relative to a preponderance of the gap 25. The visual reference 30, generally speaking, has a first or outwardly facing surface 31, and a second or inwardly facing surface 32. It further has a proximal end 33, and an opposite, or distal end 34. Still further, a space or channel 35 is formed between the proximal, or first end 33, and the bottom surface 22 of the downwardly oriented supporting surface 20. The first or outwardly facing surface 31 is coated or otherwise treated in a manner to provide an appearance or reflecting surface which allows the visual inspection assembly, as will be described in greater detail hereinafter, to be periodically adjusted or calibrated, during the sorting process so as to provide reliable sorting information. Still further, as seen in the drawings, the distal end 34, is immediately juxtaposed into facing engagement, and is affixed to the bottom surface 22 of the downwardly oriented supporting surface 20. It should ‘be noted that the space or channel 35 is provided so as to form an air flow path or channel which will be discussed in greater detail, below. As best understood by reference to FIG. 4, the downwardly oriented supporting surface has a beveled edge 36 which defines, at least in part, the peripheral edge of the gap 25. The function of this beveled edge will also be discussed in greater detail, below.

A second form of a visual reference and which is generally indicated by the numeral 40 is best depicted in FIGS. 5-7, respectively. The second form of the visual reference 40 includes a circular main body 41 which has a peripheral edge 42, and which has a predetermined direction of rotation 43. As seen in the drawings, the peripheral edge 42 is treated, or otherwise fabricated in a manner similar to the previously described outside facing surface 31 of the visual reference 30. Still further, as seen in FIGS. 5-7, the direction of rotation 43, as seen in those drawings, is depicted as moving against the direction of travel of the source of product to be sorted which is moving, under the influence of gravity, down the top surface 21 of the downwardly oriented supporting surface 20. The rotation of the circular main body 41 has the effect of, at least in part, maintaining the peripheral edge 42 substantially clear of dirt, debris, or other contamination which might be deposited on same as the source of product to be sorted 14 moves down the downwardly oriented supporting surface.

As best seen in FIG. 1, the present invention 10 includes a source of a continuous reduced pressure air source 50 which is delivered by means of a conduit or other similar means 51 to the space or channel 35 which is defined between the proximal end 33, of the visual reference 30, and the bottom surface 22 of the downwardly facing supporting surface 20. In this arrangement, the source of continued reduced pressure air flow 50 is delivered to the channel 35, at a volume and a pressure which is sufficient to support the movement or travel of the substantially continuous source of product 14 to be inspected across the gap 25, and without substantially disturbing the downwardly directed path of travel of the continuous source of products 14 to be inspected. This source of air flow substantially prevents the deposit of any debris or contamination on the visual reference 30 or 40. As should be understood, this debris, if deposited, could prevent the visual reference from being effectively illuminated, and then imaged by the visual inspection assembly which will be discussed in greater detail in the paragraphs, below. As can be seen by the drawings, the visual references used with the present invention may be stationary, as seen by the numeral 30, or on the other hand, the visual reference may be moveable or rotatable 40. Still further, the source of the continuous reduced pressure air flow 50 can have a substantially fixed flow rate and pressure, or on the other hand, may be rendered adjustable as to flow rate and pressure depending on the product 14. Further, the beveled edge 36 facilitates a substantially laminar flow and prevents any turbulence from being created which would disturb the products passing through the gap 25.

As seen in FIG. 7, and in still another form of the invention, a pair of rotating references 40 may be positioned on opposite sides of the downwardly oriented supporting surface 20, and located within the vicinity of the gap 25. As seen in this arrangement, at least one of the visual references 40 is oriented in at least partial, covering relation, relative to the gap 25.

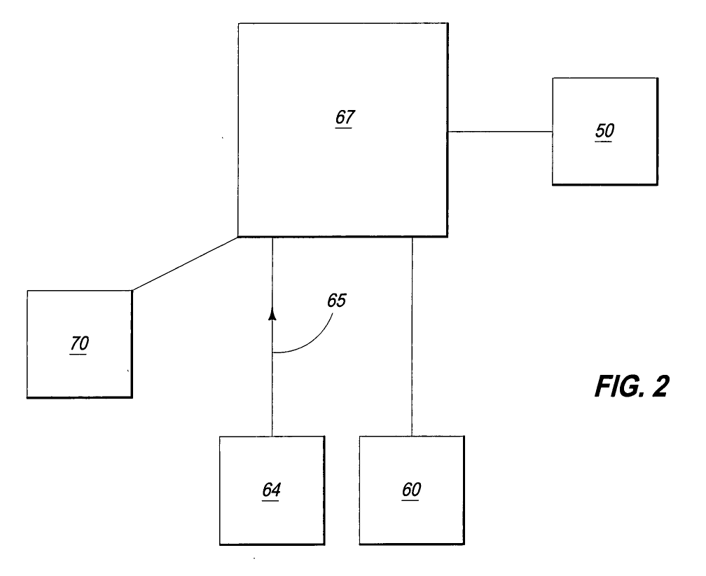

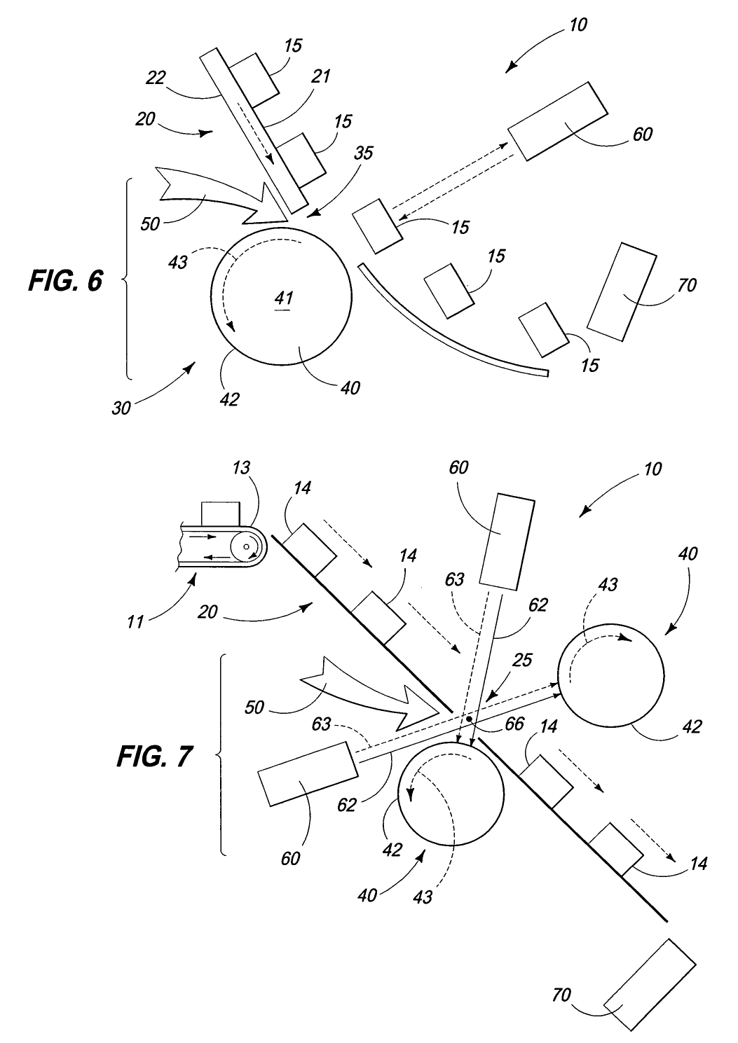

As seen in FIG. 1 and following, the sorting apparatus 10 of the present invention includes a visual inspection assembly 60 which is located in spaced relation relative to a first inspection station as defined by the gap 25 and which is operable to illuminate and image along a line of reference 66 which is positioned within the gap 25, and substantially transversely relative to the respective downwardly directed paths of travel of the multiplicity of both acceptable and unacceptable products 14. As will be discussed below, the visual inspection assembly, which is generally indicated by the numeral 60, provides an electrical signal 65 which identifies acceptable, and unacceptable products which move through the gap 25. In the arrangement as illustrated, the visual inspection assembly 60 may include a laser-scanner or flying-spot scanner, which are well understood by those skilled in the art. Still further, and as seen in FIG. 7, and in one form of the invention, the sorting apparatus 10 may include a pair of visual inspection assemblies which are generally indicated by the numeral 60, and which are configured so as to image opposite sides of the source of product to be sorted 14 as it passes through the gap 25. As best understood from a study of FIG. 1, the visual inspection assembly 60 includes an illumination device 61 which is operable to provide illumination, that being, electromagnetic radiation 62 which is directed towards the gap 25, and along the line of reference 66, as discussed, above. The electromagnetic radiation may be visible, invisible or combinations of both. Still further, the emitted electromagnetic radiation 62 is reflected from the source of products to be sorted 14 which are passing through the gap 25, or is otherwise reflected from the outwardly facing surface of the visual reference 30 or 40, depending upon the form of the invention being employed. Electromagnetic radiation 62, which is reflected, 63, is returned from the region of the gap 25, and is received by a camera or other electromagnetic radiation sensor which is generally indicated by the numeral 64 (FIG. 1). As noted earlier, the electromagnetic radiation may be visible, invisible or combinations of same. After receiving and processing the electromagnetic radiation which has been reflected 63 from the area of the gap 25, a suitable electrical signal 65 (FIGS. 1 and 2) is generated, and which is supplied to a general purpose computer that is generally indicated by the numeral 67. The general purpose computer thereafter processes the electrical signal 65, and subsequently makes a determination of whether the product 14, that has been imaged, and which is passing through the gap 25 is either, on the one hand, acceptable product 15, or unacceptable product/foreign material 16. It should be understood that while the present device 10 is shown to have a visual inspection assembly 60 having a discrete illumination device 61, and a discrete camera or other electromagnetic radiation sensor 64, it will be appreciated that these structures may be incorporated into a single unit which may be employed in the manner as discussed above, and seen in FIGS. 6 and 7.

A product rejection assembly is provided, and which is generally indicated by the numeral 70 in FIG. 1 and following. The product rejection assembly 70 is positioned in a second sorting station 71, and which is located downstream relative to the second or distal end 24 of the downwardly oriented supporting surface 20. The product rejection assembly 70 is coupled in signal receiving relation relative to the visual inspection assembly 60 by way of the general purpose computer 67 (FIG. 2). As earlier discussed, the general purpose computer 67, upon receiving the signal 65 which is generated by the visual inspection assembly 60, is operable to identify or otherwise differentiate between acceptable product 15, and unacceptable product 16 passing through the gap 25. In response to the signal received from the visual inspection assembly 60, the product rejection station 70 removes unacceptable products 16 which have been identified by the general purpose computer 67 from the downwardly directed paths of travel of the source of product to be sorted 14 so as to produce a continuous source of product 73 having only individual acceptable products. This product rejection assembly 70 is usually an air manifold which provides a blast of pressurized air or other gaseous fluid 74 in response to a signal generated by the general purpose computer 67 at a precise time period so as to remove the undesirable product 16 from the flow of product 14. The operation of this air manifold 70, as well as the general purpose computer 67 which is utilized to identify acceptable unacceptable products is well known in the art and therefore is not discussed in significant detail herein. Additionally, the air flow provided by the gap has the effect of blowing away light weight debris from the flow of product moving across the gap 25.

### Operation

The operation of the described embodiments of the present invention are believed to be readily apparent, and are briefly summarized at this point.

In its broadest aspect, a sorting apparatus 10 of the present invention includes a substantially continuous source of a product 14 to be sorted; and a downwardly oriented supporting surface 20 for guiding the source of product 14 for movement, at least in part, under the influence of gravity, along a path of travel through a first location or station 26 which is oriented along the supporting surface 20, and wherein the product 14 is first inspected, and then travels to a second station or location 71, which is located off the supporting surface 20, and wherein, at the second location 71, individual defective products 16 are removed from the substantially continuous source of product 14 to be sorted. As earlier noted, in one form of the invention 10, the downwardly oriented supporting surface 20 is discontinuous, and defines a gap 25 in a first location 26, and wherein the substantially continuous source of the product 14 to be inspected travels across the gap. In the arrangement as seen in the drawings, the invention further includes a visual inspection assembly 60 which is located in spaced relation relative to the first location 26, and which further repeatedly illuminates, and then images along a line 66 within the gap 25, and which is substantially transverse relative to the path of travel of the source product 14 which is being inspected, and which is moving along the downwardly oriented supporting surface 20. The invention 10 also includes an air manifold, or other product rejection assembly 70, which is coupled with a source of air, or other fluid under pressure (not shown), and which is effective, when delivered to the product rejection assembly 70, to remove individual unacceptable or defective products 16 from the source of the substantially continuous product 14 traveling downwardly along the supporting surface 20.

More specifically, the sorting apparatus 10 of the present invention 10 includes a substantially continuous source of a discrete product 14 to be sorted, and which includes a multiplicity of both acceptable products 15, and unacceptable products including foreign objects 16. The invention 10 also includes a supporting surface 20 for guiding the continuous source of the discrete product 14 along a downwardly directed path of travel through a first inspection station 26, and a second sorting station 71. The supporting surface 20 simultaneously facilitates the acceleration of the substantially continuous source of product 14 to about a free-fall speed, and further orients the multiplicity of both acceptable and unacceptable products 15 and 16 into a single layer. The supporting surface 20, as seen in the drawings, is discontinuous, and defines a gap 25 in the region of the first inspection station 26. The invention 10 further includes a stream of compressed air 50, which is introduced into the gap 25, and which is effective in supporting the substantially continuous source of discreet product 14 for movement across the gap 25, while not substantially changing the respective downwardly directed paths of travel of the multiplicity of both acceptable and unacceptable products 15 and 16, respectively. This source of compressed air may also remove other lightweight contaminants 16 like paper, plastic and the like which are moving along with the acceptable and unacceptable products. The invention also includes a visual inspection assembly 60, which is located in spaced relation relative to the first inspection station 26, and which illuminates 61, and images 64 along a line of reference 66 which is positioned within the gap 25, and substantially transverse to the respective downwardly directed paths of travel of the multiplicity of both acceptable and unacceptable products 15 and 16, respectively. The visual inspection assembly 60 provides a signal 65 which identifies unacceptable products 16 which move through the gap 25. The invention 10 also discloses a product rejection assembly 70 which is positioned in the second sorting station 71, and which is coupled in signal receiving relation relative to the visual inspection assembly 60 (FIG. 2). In response to an electrical signal 65 which is received from the visual inspection assembly 60, the product rejection assembly 70 removes identified unacceptable products 16 from the downwardly directed paths of travel so as to produce a continuous source of product 14 having only individual acceptable products 15. As earlier discussed, the supporting surface 20 may have a multiplicity of shapes, as measured in the direction of travel of the acceptable and unacceptable products 15 and 16, that may be concavely curved; or convexly curved; or is substantially planar; or combinations of the foregoing. All of these configurations are seen in FIGS. 3A-D, respectively. In addition to the foregoing, the present invention includes a visual reference 30 or 40 which is located in spaced relation relative to the first, or top side 21 of the downwardly facing supporting surface 20, and is located, at least in part, in partial covering relation relative to the gap 25. The visual inspection assembly 60 illuminates, and then images, at least in part, the visual reference 30 or 40. Still further, a space or channel 35 is defined between a portion of the visual reference 30 and 40, and one of the sides of the supporting surface 20, and wherein the stream of compressed air 50 passes through the channel and is utilized to support the products 14 being inspected as they travel across the gap 25. As best seen in the present invention in FIG. 7, the sorting apparatus 10 can, in one form of the invention, provide a second visual inspection assembly 60, and a second visual reference 40 which is spaced from the first mentioned visual reference as seen in FIG. 1 and following.

Therefore, it will be seen that the present invention provides a convenient means whereby a source of product to be sorted may be conveniently imaged and defective product readily identified so that they may be removed so that a final resulting product having only acceptable products is produced.

In compliance with the statute, the invention has been described in language more or less specific as to structural and other methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the Doctrine of Equivalents.

I claim:

1. A sorting apparatus, comprising:
a substantially continuous source of a product to be sorted; and
a downwardly oriented supporting surface for guiding the source of product for movement, at least in part, under the influence of gravity, along a path of travel through a first location which is oriented along the supporting surface, and where the product is first inspected, and then travels to a second location, which is located off the supporting surface, and where, at the second location, individual defective products are removed from the substantially continuous source of product to be sorted.

2. A sorting apparatus as claimed in claim 1, and wherein the substantially continuous source of the product to be sorted includes a multiplicity of individual and discrete products which have both acceptable and unacceptable characteristics.

3. A sorting apparatus as claimed in claim 1, and wherein the downwardly oriented supporting surface facilitates the substantially continuous source of the products to be sorted to accelerate to a speed which approximates free-fall.

4. A sorting apparatus as claimed in claim 1, and wherein the downwardly oriented supporting surface facilitates the acceleration of the substantially continuous source of product to a speed where individual products within the continuous source of the products to be sorted move along substantially parallel paths of travel, and further have no substantial movement in a direction which is transverse to the respective parallel paths of travel.

5. A sorting apparatus as claimed in claim 4, and wherein the downwardly oriented supporting surface facilitates the orientation of the substantially continuous source of product to be sorted into a single layer.

6. A sorting apparatus as claimed in claim 1, and further comprising a visual inspection assembly which is located in spaced relation relative to the first location, and which further repeatedly illuminates, and then images along a line within the first location which is substantially transverse relative to the path of travel of the source of the product moving along the downwardly oriented supporting surface.

7. A sorting apparatus as claimed in claim 6, and wherein the visual inspection assembly includes a laser-scanner or flying spot scanner.

8. A sorting apparatus as claimed in claim 6, and wherein the visual inspection assembly includes a pair of visual inspection assemblies.

9. A sorting apparatus as claimed in claim 1, and wherein the downwardly oriented supporting surface has a shape, as measured in the direction of travel of the substantially continuous source of product to be inspected, that is concavely curved; or convexly curved; or substantially planar; or combinations of the foregoing.

10. A sorting apparatus as claimed in claim 1, and wherein the downwardly oriented supporting surface comprises a material which does not substantially frictionally impede the movement of the continuous source of the product while moving under the influence of gravity along the downwardly oriented supporting surface.

11. A sorting apparatus as claimed in claim 1, and wherein the downwardly oriented supporting surface is stationary.

12. A sorting apparatus as claimed in claim 1, and wherein the downwardly oriented supporting surface is at least in part moveable.

13. A sorting apparatus as claimed in claim 1, and wherein the downwardly oriented supporting surface includes a stationary portion, and a moveable portion.

14. A sorting apparatus as claimed in claim 1, and wherein the downwardly oriented supporting surface is continuous.

15. A sorting apparatus as claimed in claim 1, and wherein the downwardly oriented supporting surface is discontinuous, and defines a gap in the first location, and wherein the substantially continuous source of the product to be inspected travels across the gap.

16. A sorting apparatus as claimed in claim 15, and further comprising a visual inspection assembly which is located in spaced relation relative to the first location, and which further repeatedly illuminates, and then images, along a line within the gap, and which is substantially transverse relative to the path of travel of the source of the product which is being inspected, and which is moving along the downwardly oriented supporting surface; and wherein an air manifold which is coupled with a source of air under pressure, is located in spaced relation relative to the second location, and which, when made operational, is effective in removing individual defective products from the source of the substantially continuous product traveling along the downwardly oriented supporting surface.

17. A sorting apparatus as claimed in claim 16, and further comprising a second visual inspection assembly which is located in spaced relation relative to the first location, and further spaced from the first mentioned visual inspection assembly, and which when energized repeatedly illuminates, and then images along a line within the gap and which is substantially transverse relative to the path of travel of the source of product which is being inspected.

18. A sorting apparatus as claimed in claim 16, and further comprising:
a visual reference which is located in spaced relation relative to a first side of the downwardly oriented supporting surface, and in covering relation relative to a portion of the gap, and wherein the visual inspection assembly illuminates, and then images, at least in part, a portion of the visual reference, and wherein a channel is defined, at least in part, between a portion of the downwardly oriented supporting surface and the visual reference; and
a source of a continuous, reduced pressure air flow delivered to the channel, and which is of a volume and a pressure which is sufficient to support the movement of the substantially continuous source of the product to be inspected across the gap, and without substantially disturbing the path of travel of the continuous source of the products to be inspected, while simultaneously preventing the deposit of any debris on the visual reference so as to prevent it from being effectively illuminated, and then imaged by the visual inspection assembly.

19. A sorting apparatus as claimed in claim 18, and further comprising:
a second visual inspection assembly positioned in spaced relation relative to the first location and the gap, and wherein the pair of visual inspection assemblies both illuminate and then image, at least in part a region of the gap; and
first and second visual references located in spaced relation relative to opposite sides of the downwardly oriented supporting surface, and wherein at least one of the visual references is oriented in at least partial covering relation relative to the gap.

20. A sorting apparatus as claimed in claim 18, and wherein the visual reference is stationary.

22. A sorting apparatus as claimed in claim 18 and wherein the visual reference is moveable.

23. A sorting apparatus as claimed in claim 18, and wherein the source of the continuous, reduced pressure airflow has a substantially fixed flow rate, and pressure.

24. A sorting apparatus as claimed in claim 18, and wherein the source of the continuous, reduced pressure airflow is adjustable as to the flow rate and pressure.

25. A sorting apparatus, comprising:
a substantially continuous source of a discrete product to be sorted, and which includes a multiplicity of both acceptable products, and unacceptable products;
a supporting surface for guiding the continuous source of the discrete product along a downwardly directed path of travel through a first inspection station, and a second sorting station, and wherein the supporting surface simultaneously facilitates the acceleration of the substantially continuous source of product to about a free-fall speed, and further orients the multiplicity of both acceptable and unacceptable products into a single layer, and wherein the supporting surface is discontinuous and defines a gap in the first inspection station;
a stream of compressed air which is introduced into the gap, and which is effective in supporting the substantially continuous source of discreet product for movement across the gap, while not substantially changing the respective downwardly directed paths of travel of the multiplicity of both acceptable and unacceptable products; a visual inspection assembly which is located in spaced relation relative to the first inspection station, and which illuminates and images along a line of reference which is positioned within the gap, and substantially transversely relative to the respective downwardly directed paths of travel of the multiplicity of both acceptable and unacceptable products, and wherein the visual inspection assembly provides a signal which identifies unacceptable products which move through the gap; and
a product rejection assembly positioned in the second sorting station, and which is coupled in signal receiving relation relative to the visual inspection assembly, and where, in response to a signal received from the visual inspection station, the product rejection station removes identified unacceptable products from the downwardly directed paths of travel so as to produce a continuous source of product having only individual acceptable products.

26. A sorting apparatus as claimed in claim 25, and wherein the downwardly directed paths of travel of the respective acceptable and unacceptable products do not move transversely one relative to the others.

27. A sorting apparatus as claimed in claim 25, and wherein the visual inspection assembly includes a laser scanner and/or a flying spot scanner.

28. A sorting apparatus as claimed in claim 25, and wherein the supporting surface has a shape, as measured in the direction of travel of the acceptable and unacceptable products, that is concavely curved; or convexly curved; or is substantially planar; or combinations of the foregoing.

29. A sorting apparatus as claimed in claim 25, and wherein the supporting surface is fabricated from a material that does not substantially frictionally impede the movement of the acceptable and unacceptable products along the individual downwardly directed paths of travel.

30. A sorting apparatus as claimed in claim 25, and wherein the supporting surface has a first, and an opposite second side, and wherein the first side is juxtaposed relative to the individual paths of travel of the acceptable and unacceptable products, and wherein the gap extends between the first and second sides, and wherein the sorting apparatus further comprises:
a visual reference which is located in spaced relation relative to the second side of the supporting surface, and in at least partial covering relation relative to the gap, and wherein the visual inspection assembly illuminates, and then images, at least a part of, the visual reference, and wherein a channel is defined between a portion of the visual reference, and the second side of the supporting surface, and wherein the stream of compressed air passes through the channel.

31. A sorting apparatus as claimed in claim 25, and wherein the visual reference is stationary or moveable.

32. A sorting apparatus as claimed in claim 25, and wherein the stream of compressed air has a volume, and pressure, which is substantially constant or adjustable.

33. A sorting apparatus as claimed in claim 30, and further comprising:
a second visual inspection assembly spaced from the supporting surface; and
a second visual reference which is spaced from the first mentioned visual reference.
